(19) United States
(12) Patent Application Publication
(10) Pub. No.: US 2020/0321678 A1
(43) Pub. Date: Oct. 8, 2020

(54) ADJUSTABLE ANTENNA MOUNT

(71) Applicant: CommScope Technologies LLC, Hickory, NC (US)

(72) Inventors: Ian RENILSON, Dalgety Bay (GB); Thomas Cunningham TULLOCH, Burntisland (GB); James Michael JEFFERSON, Glenrothes (GB); Donald GARDNER, Livingston (GB)

(21) Appl. No.: 16/310,991

(22) PCT Filed: Aug. 23, 2017
(86) PCT No.: PCT/US2017/048129

§ 371 Date: Dec. 18, 2018

Related U.S. Application Data
(60) Provisional application No. 62/384,396, filed on Sep. 7, 2016.

(51) Int. Cl. H01Q 1/12; H01Q 3/08; H01Q 15/16

(52) U.S. Cl. CPC H01Q 1/1228; H01Q 15/16; H01Q 3/08

(57) ABSTRACT

An antenna mount includes a pivot saddle rotatably coupled to a pivot base. The azimuth angle of an antenna changes as the pivot saddle rotates about the pivot base. The pivot base and the pivot saddle further comprise a unitary folded metal part.

### CROSS REFERENCE TO RELAXED APPLICATION

The present application claims priority under 35 U.S.C. § 119 from U.S. Provisional Application Ser. No. 62/384,396, entitled “ADJUSTABLE ANTENNA MOUNT,” filed on Sep. 7, 2016, the entire disclosure of which is hereby incorporated by reference herein for all purposes as if set forth in its entirety.

### FIELD OF THE INVENTION

This invention relates to antenna mounts. More particularly, the invention relates to adjustable antenna mounts for reflector antennas.

### BACKGROUND

Reflector antennas, such as terrestrial microwave reflector antennas, are highly directional. For improved antenna gain performance, the antenna mount of a reflector antenna may be adjustable in both azimuth and elevation to obtain a boresight alignment between antenna pairs that form an RF communications link. The antenna mount should maintain the selected alignment despite exposure over time to wind and/or ice loads acting upon the reflector antenna. Depending on the installation location, such loads can be significant, particularly during extreme weather events.

As the distance to the target antenna increases, even very small alignment shifts in the azimuth and/or elevation of an antenna become significant. Should the antenna mount lose the desired boresight alignment, for example due to transient wind and/or ice loads, a significant expense may be incurred to have a technician return to a remote location, such as atop a radio tower, and repeat the alignment procedure. Misalignment can also occur when an antenna mount is clamped into place. That is, the act of clamping the mount can cause undesirable changes to the azimuth and/or elevation of the antenna.

The sensitivity of antenna positioning is frequency dependent. For example, as the frequency of microwave signals transmitted/received by the antenna increases, the beamwidth of the signal decreases. Thus, minor shifts in azimuth and/or elevation of the antenna can result in greater loss of antenna gain.

Only a few years ago, the highest frequency of microwave antennas was 38 GHz. The highest frequency is now 80 GHz, with discussions to go significantly higher. As the communication industry moves to the use of higher frequencies for microwave communications, it becomes more important for antenna mounts to maintain the alignment of the antenna even in the presence of loading.

A conventional measure for alignment stability is the 0.3×0.3 dB beamwidth of the antenna, which decreases significantly with frequency. For example, at 38 GHz; the 0.3×0.3 dB beamwidth for one popular antenna at 38 GHz is 0.27°. In contrast, the 0.3×0.3 dB beamwidth for the same antenna at 80 GHz is only 0.15°.

In general, there is a trade-off between the ease with which the alignment of an antenna can be adjusted and the alignment stability of an antenna mount on the one hand and the manufacturing cost, weight and dimensional characteristics of the antenna meant on the other hand. For example, conventional approaches may use die casting or extrusion manufacturing techniques to form the antenna mount. Such techniques can be costly and can increase the weight and/or size of the resulting antenna mount. FIGS. 16 and 17 illustrate conventional mounts that use such manufacturing techniques.

### BRIEF DESCRIPTION OF THE DRAWINGS

FIG. 1 is a perspective view of an antenna mount according to some embodiments that is affixed to a support pole.

FIG. 2 is a top view of the antenna mount of FIG. 1.

FIG. 3 is a side view of the antenna mount of FIG. 1.

FIGS. 4 and 5 are perspective views of the antenna mount of FIG. 1.

FIG. 6 is a perspective view of an antenna assembly mounted to a support pole using an antenna mount according to some embodiments.

FIGS. 7A to 7C are top views of an antenna assembly mounted to a support pole using an antenna mount according to some embodiments and positioned at various azimuth adjustments.

FIGS. 8A and 8B are top views of an antenna mount according to some embodiments affixed to support poles of different diameters.

FIG. 9 is a top view of a mounting bracket showing how it contacts support poles of various diameters.

FIGS. 10(A) to 10(E) are several views of a pivot saddle of an antenna mount according to some embodiments.

FIGS. 11(A) to 11(D) are several views of a pivot base of an antenna mount according to some embodiments.

FIGS. 12(A) to 12(F) are several views of an azimuth adjustment fastening block of an antenna mount according to some embodiments.

FIGS. 13(A) to 13(E) are several views of a mounting bracket of an antenna mount according to some embodiments.

FIGS. 14(A) and 14(B) are views of a mounting bracket of an antenna mount according to further embodiments.

FIGS. 15(A) to 15(E) are several views of an elevation adjustment fastening block of an antenna mount according to some embodiments.

FIGS. 16 and 17 illustrate conventional antenna mounts.

### DETAILED DESCRIPTION OF EMBODIMENTS

An adjustable antenna mount according to some embodiments includes a pivot base and a pivot saddle that is rotatably attached to the pivot base. In an embodiment, both the pivot base and the pivot saddle may be formed from pressed steel as unitary folded metal parts, with the resulting assembly having light weight and/or high strength. Moreover, by being formed from pressed steel instead of, for example, die casting or extrusion techniques, the resulting assembly may be manufactured at relatively low cost.

An adjustable antenna mount according to some embodiments may include elevation and azimuth adjustment mechanisms that resist movement over time, such as in response to a wind or ice load, which can reduce the total cost of maintenance of the antenna. For example, the elevation and azimuth adjustment mechanisms may include fastening blocks against which a retaining nut or an adjustment bolt can be tightened. The presence of fastening blocks may enable retaining nuts and/or adjustment bolts to remain tight even under the influence of heavy loads and over a wide range of ambient temperatures. The fastening blocks may be formed from a glass fiber reinforced injection molding resin, such as VALOX Resin 420, which has desirable material properties. Machined nylon polymer may also be utilized for some components. In some embodiments, the fastening blocks may be die cast metal, such as die cast zinc. Thus, a retaining nut or adjustment bolt that is tightened against the fastening block may remain tight over time, thereby reducing misalignment of the antenna.

An azimuth adjustment fastening block may be supported by a pivot arm support plate that extends from the pivot base. The azimuth adjustment fastening block may have a slot formed therein so that it can slide into place over the pivot arm support plate. An azimuth pivot arm may extend through the azimuth adjustment fastening block and the pivot arm support plate. An end of the azimuth pivot arm may be connected to the pivot saddle through an eye bolt that allows the pivot saddle to rotate relative to an azimuth pivot bolt when the azimuth pivot arm is extended/retracted through the pivot arm support plate.

In an embodiment, the pivot base may include a receiving cavity that engages a support pole. The receiving cavity includes a pair of receiving surfaces that are arranged to form an obtuse angle, so that at least a portion of the support pole can fit into the receiving cavity. The receiving surfaces may be generally linear, and may include a plurality of teeth arranged to engage support poles of various sizes. In particular, the teeth may be arranged such that at least two teeth on each receiving surface engage the outer surface of the support pole when the support pole is brought in to contact with the receiving surfaces, for support poles having various conventional diameters.

An adjustable antenna mount according to some embodiments also includes an elevation adjustment slot that is tilted relative to vertical to reduce offset to an adjustment bolt.

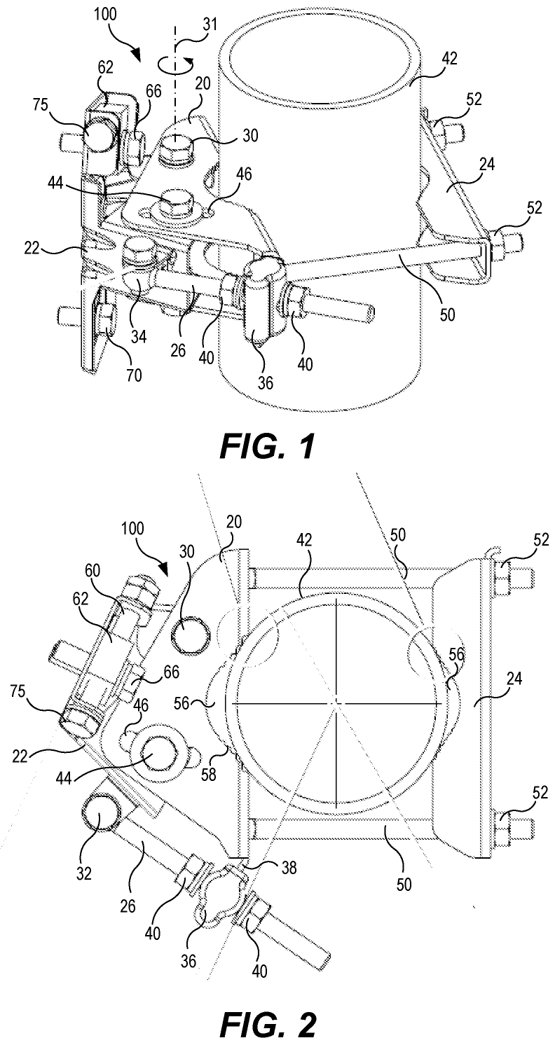

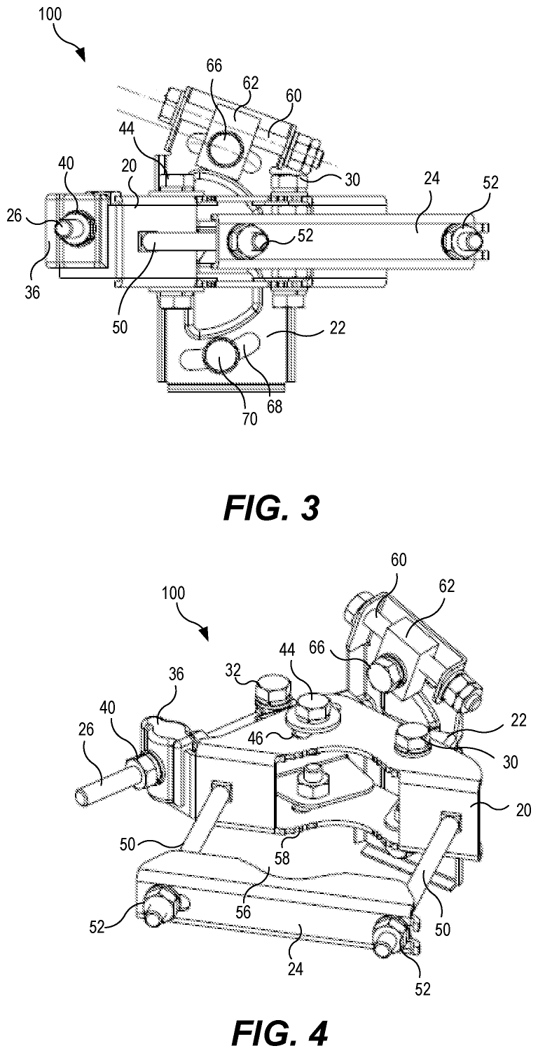

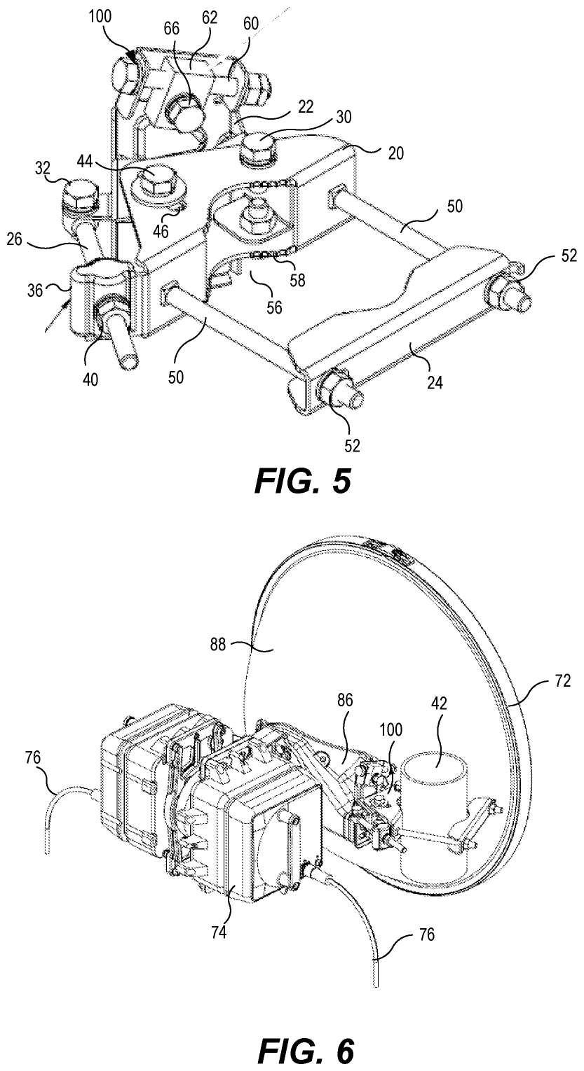

Reference is now made to FIGS. 1 to 5 which illustrate an antenna mount 100 according to some embodiments. In particular, FIG. 1 is a perspective view of an antenna mount 100 that is affixed to a support pole 42, FIG. 2 is a top view of the antenna mount 100 affixed to the support pole 42, FIG. 3 is a side view of die antenna mount 100 alone, and FIGS. 4 and 5 are perspective views of the antenna mount alone.

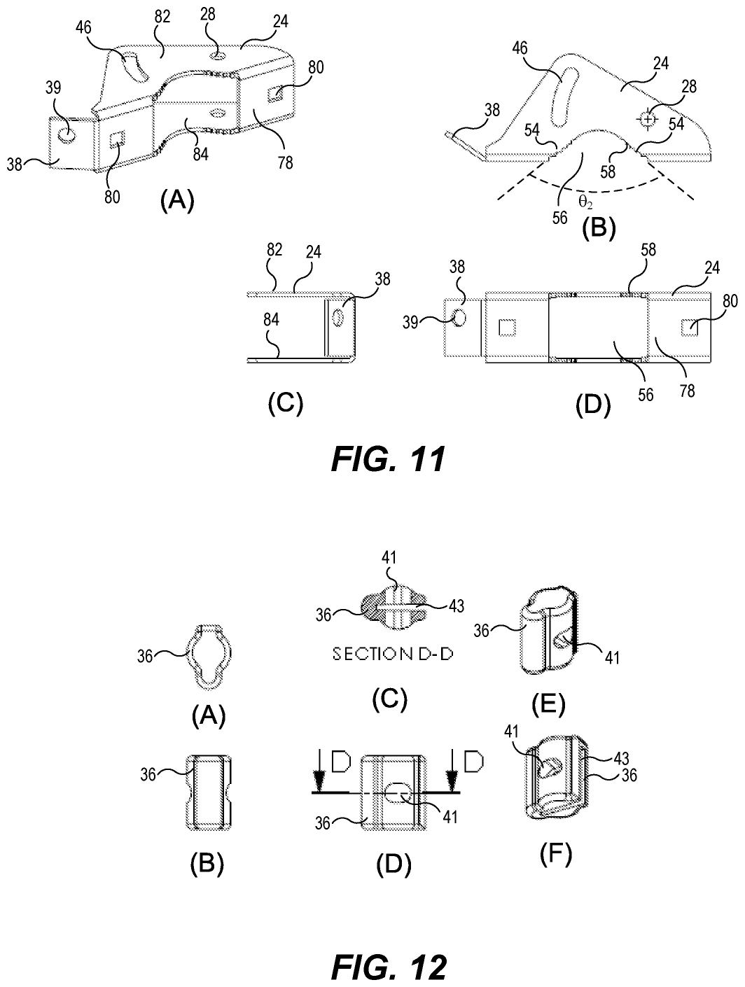

Referring to FIGS. 1 to 5, the antenna mount 100 is provided to mount an antenna assembly 72 (FIG. 6) to a support member, such as a support pole 42. The antenna mount 100 includes a pivot base 20 and a pivot saddle 22 that is rotatably attached to the pivot base 20. The antenna assembly 72 attaches to the pivot saddle 22. The azimuth of the antenna assembly 72 may be adjusted by rotating the pivot saddle 22 about an azimuth pivot bolt 30 that extends through an azimuth pivot hole 28 (FIG. 11) and into the pivot saddle 22. The azimuth pivot bolt 30 extends along a vertical axis 31 about which the pivot saddle 22 rotates to adjust the azimuth of the antenna. Rotation of the pivot saddle 22 about the vertical axis 31 corresponding to the center of the azimuth pivot bolt 30 occurs in response to linear motion of an azimuth pivot arm 26 that is slidably coupled to the pivot base 20 through a pivot arm support plate 38 that extends from the pivot base 20. The azimuth pivot arm 26 is rotatably coupled to the pivot saddle 22 through an eye bolt 34 at the end of the azimuth pivot arm 26. The azimuth pivot arm 26 may be a threaded bolt that is held in place on the pivot arm support plate 38 by a pair of opposing pivot arm retaining nuts 40. The eye bolt 34 and the azimuth pivot arm 26 may be integrally formed. That is, the azimuth pivot arm 26 may be an elongated threaded eye bolt.

An azimuth adjustment fastening block 36 is affixed to a pivot arm support plate 38 that extends from the pivot base 20. In particular, the azimuth adjustment fastening block 36 may have a slot formed therein so that it can slide in place over the pivot arm support plate 38. The azimuth pivot arm 26 extends through the azimuth adjustment fastening block 36 and the pivot arm support plate 38. During azimuth adjustment, the azimuth pivot arm 26 may move linearly through the pivot arm support plate 38. An azimuth adjustment guide bolt 44 extends through an arcuate azimuth adjustment slot 46 in the pivot base 20 and into the pivot saddle 22. The azimuth adjustment slot 46 describes an arc having as its center of revolution the azimuth pivot hole 28 (FIG. 11(A)) in which the azimuth pivot bolt 30 is positioned, i.e., the center of rotation of the azimuth adjustment slot 46 is the vertical axis 31. As the pivot saddle 22 is rotated about the azimuth pivot bolt 30, the azimuth adjustment guide bolt 30 moves through the azimuth adjustment slot 46. The size of the azimuth adjustment slot 46 and the distance of the azimuth adjustment slot 46 from the azimuth pivot bolt 30 limits the amount of azimuth adjustment that can be obtained. In some embodiments, the azimuth adjustment slot 46 may be sized to allow the pivot saddle to rotate about the azimuth pivot bolt 30 by up to about 30 degrees, or a maximum of +/−15 degrees from a nominal (neutral) setting.

Once the azimuth of the antenna has been adjusted, the azimuth pivot arm 26 may be fixed in place so as to maintain the azimuth adjustment by tightening pivot arm retaining nuts 40 on opposite sides of the azimuth adjustment fastening block 36. In some embodiments, the azimuth adjustment fastening block 36 may be formed of a molded plastic material. In particular, the azimuth adjustment fastening block 36 may be formed from VALOX Resin 420, which has desirable mechanical characteristics. The presence of the azimuth adjustment fastening block 36 between the retaining nuts 40 may enable the pivot arm retaining nuts 40 to remain tight even under the influence of heavy loads and over a wide range of ambient temperatures. In some embodiments, the azimuth adjustment fastening block 36 may be provided as a pair of opposing conical washers that fit over the azimuth pivot arm 26 and the pivot arm support plate 38. In other embodiments, the azimuth adjustment fastening block 36 may include a die cast metal, such as die cast zinc.

An end of the azimuth pivot arm 26 is connected to the pivot saddle 22 through an eye bolt 34 that allows the pivot saddle 22 to rotate relative to the azimuth pivot bolt 30 when the azimuth pivot arm 26 is extended/retracted through the pivot arm support plate 38.

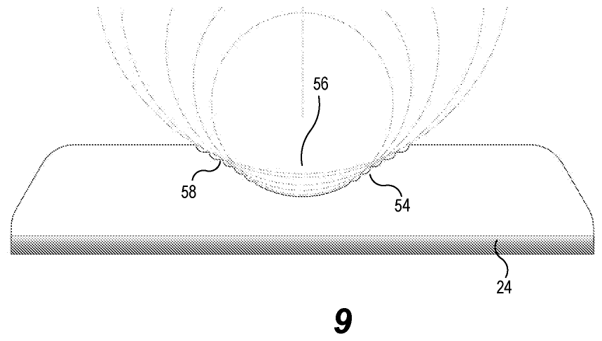

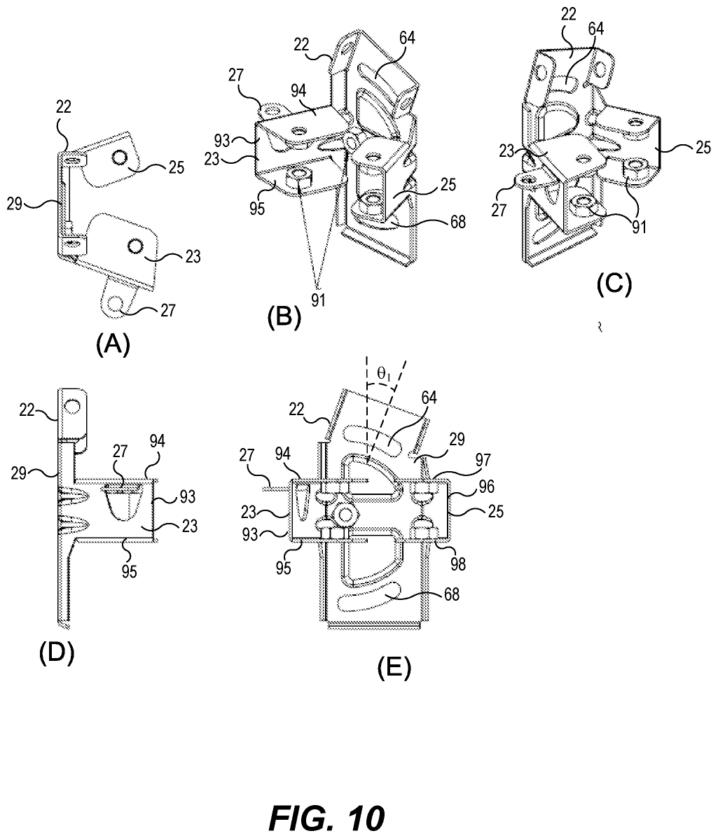

Elevation adjustment is performed by rotating the antenna assembly 72 (FIG. 6) relative to the pivot saddle 22. In particular, the antenna assembly 72 is attached to the pivot saddle 22 through upper and lower attachment bolts 66, 70, which extend through arcuate upper and lower elevation adjustment slots 64, 68 (FIG. 10(E)), respectively. The upper and lower elevation adjustment slots 64, 68 may describe arcs that have a common center of rotation.

Once the antenna elevation has been set, the upper and lower attachment bolts 66, 70 may be tightened to hold the antenna assembly 72 in place against the pivot saddle 22. It will be appreciated that only one of the upper and lower elevation adjustment slots 64, 68 may be provided in the pivot saddle 22, and that the other adjustment slot may be replaced, for example, by a hole that docs not allow the corresponding bolt to move laterally. However, by providing two elevation adjustment slots 64, 68, the amount of elevation adjustment available is increased because the radius of rotation is decreased.

An elevation adjustment fastening block 62 may be provided on an attachment bolt, such as the upper attachment bolt 66, so that when the upper attachment bolt 66 is tightened, it is tightened against the elevation adjustment fastening block 62. The elevation adjustment fastening block 62 may be formed of a material, such as machined nylon, that has appropriate mechanical characteristics. In some embodiments, tire elevation adjustment fastening block 62 may be formed from die cast metal, such as die cast zinc, or molded plastic.

The elevation adjustment fastening block 62 may include internal threads that matingly attach to a threaded elevation adjustment bolt 60 including an elevation adjustment nut 75 at an end thereof. Turning the elevation adjustment nut 75 at the end of the elevation adjustment bolt 60 causes the upper attachment bolt 66 to travel along die upper elevation adjustment slot 64, which changes the elevation of the attached antenna. The exposed elevation adjustment nut 75 may be turned, for example, using an automatic alignment adjustment tool (not shown) that detects antenna gain and that automatically rotates the elevation adjustment nut 75 until a maximum antenna gain is detected. A similar approach may be used to automatically adjust the azimuth setting of the antenna.

The presence of the elevation adjustment fastening block 62 between the upper antenna elevation bolt 66 and the pivot saddle 22 may enable the upper antenna adjustment bolt 66 to remain tight even under the influence of heavy loads and over a wide range of ambient temperatures.

The pivot base 20 is clamped to the support pole 42 using a clamp bracket 24 and carriage bolts 50. The carriage bolts 50 extend through both the pivot base 20 and the clomp bracket 24 on opposite sides of the support pole 42. A pair of retaining nuts 52 on the carriage bolts 50 lighten the pivot base 20 and the clamp bracket 24 against the support pole 42. To assist in holding the antenna mount 100 firmly against the support pole 42, the pivot base 20 includes a receiving cavity 56 on a side of the pivot base 20 facing the support pole 42, i.e., generally opposite to the pivot saddle 22. The receiving cavity 56 includes teeth 58 that engage the support pole 42. The receiving cavity 56 and the teeth 58 are configured so that for a number of common support pole diameters (e.g., 50 mm, 60 mm, 75 mm, 100 mm and 115 mm), at least four teeth 58 of the pivot base 20 (e.g., two teeth on each side of the support pole 42) will actively engage the support pole 42 when the pivot base 20 is tightened onto the support pole 42.

The clamp bracket 24 may also include a receiving cavity 56 with teeth 58, and may also be configured such that at least four teeth 58 of the clamp bracket 24 (e.g., two teeth on each side of the support pole 42) will actively engage the support pole 42 when the clamp bracket 24 is tightened onto the support pole 42.

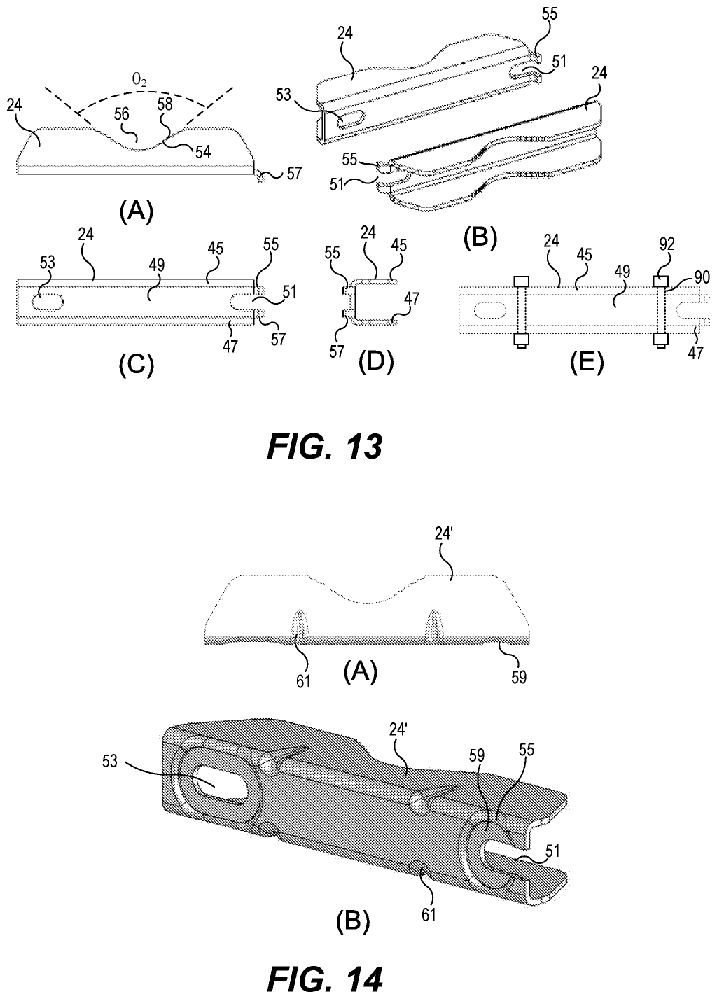

The receiving cavity 56 and teeth 58 of the pivot base 20 and the clamp bracket 24 will be described in more detail below with reference to FIGS. 11 and 13.

FIG. 6 is a perspective view of an antenna assembly 72 that is mounted to a support pole 42 using an antenna mount 100 according to some embodiments. As can be seen in FIG. 6, the antenna assembly includes an antenna dish 88 attached to an antenna bracket 86. An electronics enclosure including a radio 74 is attached to the antenna bracket 86. One or more feed cables 76 transmit/receive electrical signals to/from the antenna dish 88 through the radio 74.

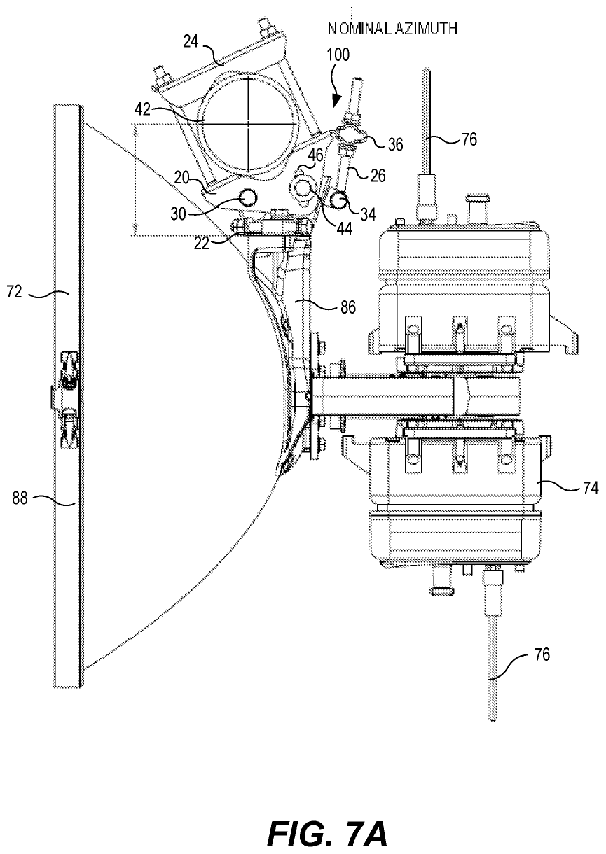

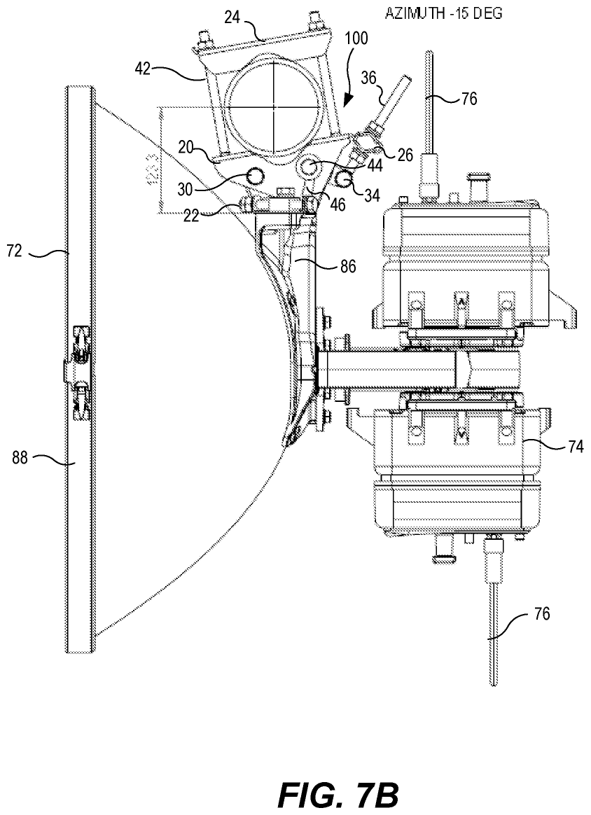

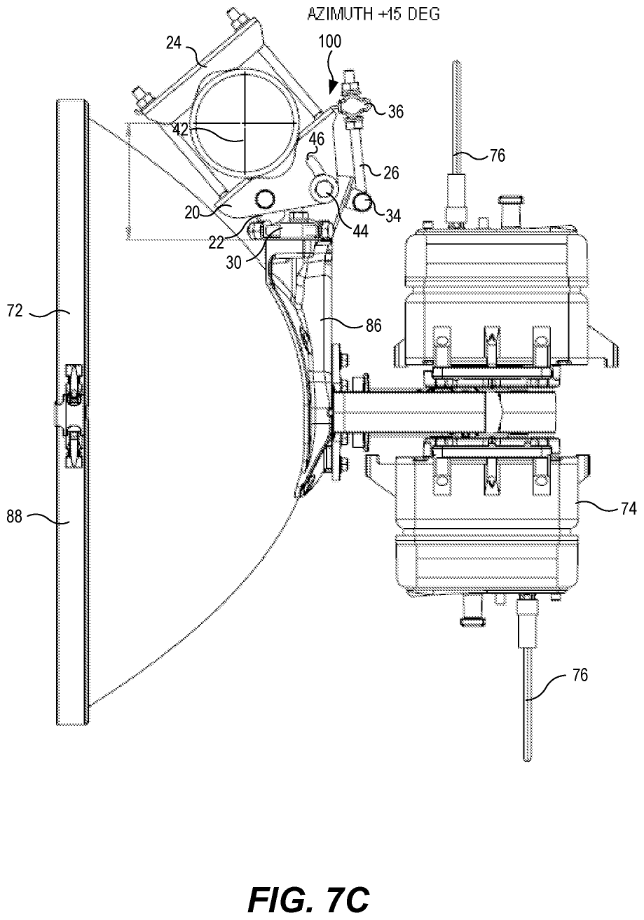

FIGS. 7A to 7C are top views of an antenna assembly 72 that is mounted to a support pole 42 using an antenna mount 100 according to some embodiments and positioned at various azimuth adjustments. In particular, FIG. 7A illustrates an antenna assembly 72 that is positioned by the antenna mount 100 at a nominal azimuth. Note that the azimuth adjustment guide bolt 44 is positioned at approximately a middle of the azimuth adjustment slot 46, and that the azimuth adjustment fastening block 36 is positioned about midway along the azimuth pivot arm 26.

FIG. 7B illustrates an antenna assembly 72 that is positioned by the antenna mount 100 at a fully reduced azimuth of −15 degrees. Note that the azimuth adjustment guide bolt 44 is positioned within the azimuth adjustment slot 46 at a position farthest from the antenna bracket 86, and that the azimuth adjustment fastening block 36 is positioned on the azimuth pivot arm 26 near the eye bolt 34 that connects to the pivot saddle 22.

FIG. 7C illustrates an antenna assembly 72 that is positioned by the antenna mount 100 at a fully increased azimuth of +15 degrees. Note that the azimuth adjustment guide bolt 44 is positioned within the azimuth adjustment slot 46 at a position nearest the antenna bracket 86, and that the azimuth adjustment fastening block 36 is positioned on the azimuth pivot arm 26 away from the eye holt 34 that connects to the pivot saddle 22.

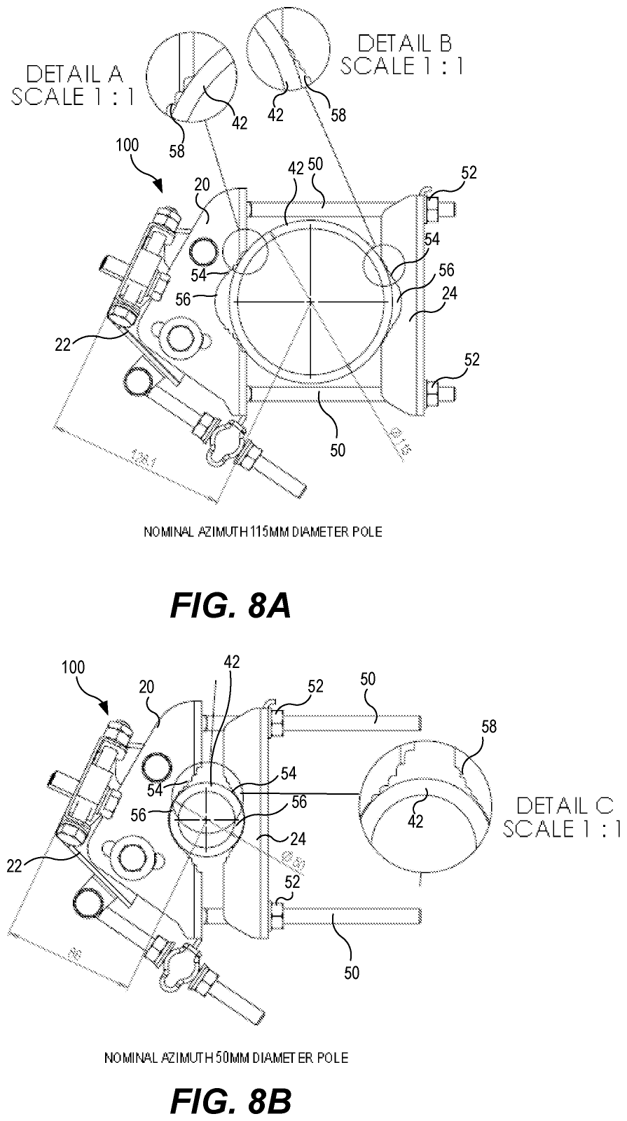

FIGS. 8A and 8B are top views of an antenna mount according to some embodiments affixed to support poles of different diameters. In particular, FIG. 8A illustrates attachment of an antenna mount 100 according to some embodiments to a 115 mm diameter pole 42. As can be seen in the Detail A and Detail B enlargements, at least two teeth 58 on both receiving surfaces 54 of the receiving cavities 56 of both the pivot base 20 and the clamp bracket 24 engage against the 115 mm diameter pole 42. FIG. 8B illustrates attachment of an antenna mount 100 according to some embodiments to a 50 mm diameter pole 42. As can be seen in the Detail C enlargement, even though the pole shown in FIG. 8B has a much smaller diameter than the pole 42 in FIG. 8A, nevertheless, at least two teeth 58 on both receiving surfaces 54 of the receiving cavities 56 of both the pivot base 20 and the clamp bracket 24 engage against the 50 mm diameter pole 42.

FIG. 9 is a top view of a clamp bracket 24 that includes a receiving cavity 56 according to some embodiments. In particular, FIG. 9 illustrates how support poles 42 with different diameters nevertheless contact at least two teeth 58 on each side of the receiving cavity 56 when the support poles 42 are brought into engagement with the receiving surfaces 56.

FIGS. 10(A) to 10(E) are several views of a pivot saddle 22 of an antenna mount 100 according to some embodiments. In particular, FIG. 10(A) is a top view, FIGS. 10(B) and 10(C) are perspective views, FIG. 10(D) is a side view and FIG. 10(E) is a front view of a pivot saddle 22 of an antenna mount 100 according to some embodiments. Referring to FIGS. 10(A) to 10(E), the pivot saddle 22 includes left and right saddle bodies 23, 25 that extend from an attachment plate 29. The left and right saddle bodies 23, 25 are fastened to the pivot body 20 via the azimuth pivot bolt 30 and the azimuth adjustment guide bolt 44. As can be seen in FIG. 10(B), upper and lower holes can be provided in the left and right saddle bodies 23, 25 so that upper and lower guide bolts and azimuth adjustment bolts can be provided.

The left saddle body 23 includes a main plate 93 that is folded away from the attachment plate 29, and upper and lower plates 94, 95 that are folded away from the main plate 93. Similarly, the right saddle body 25 includes a main plate 96 that is folded away from the attachment plate 29, and upper and lower plates 97, 98 that are folded away from the main plate 96. As such, the attachment plate 29 and the left and right saddle bodies 23, 25 may be integrally formed by stamping from a single sheet of metal.

In some embodiments, weld nuts 91 can be welded in place on the left and right saddle bodies 23, 25 to receive the upper and lower guide bolts and azimuth adjustment bolls. In other embodiments, a sleeve may be placed between adjacent guide holes instead of the weld nuts 93, and the guide bolls and pivot bolt may extend completely through the left and right saddle bodies 23, 25. In other embodiments, one or more of the weld outs 91 may be replaced with retained nuts and/or extruded threads. In further embodiments, the guide bolts may be carriage bolts.

A pivot arm receiver 27 to which the eye bolt 34 at the end of the azimuth pivot arm 26 attaches extends from the left saddle body 23. The left and right saddle bodies 23, 25 are attached to an attachment plate 29 that attaches to the antenna bracket 86 through the upper and lower attachment bolts 66, 70 (FIG. 3), which extend through the upper and lower elevation adjustment slots 64, 68. As best seen in FIG. 10(E), the upper elevation adjustment slot 64 is tilted at an angle θ₁ from the vertical direction. Likewise, the lower elevation adjustment slot 68 may also be tilted at an angle from the vertical direction. This tilting of the elevation adjustment slots 64, 68 may reduce an offset to the attachment bolts 66, 70, which may enable smoother adjustment of elevation, and/or reduce torque that can be imparted to the pivot saddle 22 when the antenna elevation angle is adjusted. Clamping the adjuster bolt between two upstanding walls can reduce undesired backlash. “Backlash” refers to undesired additional movement of die adjustment mechanism that occurs before the antenna will begin to move in response to actuation of the adjustment mechanism. Backlash, which is a hysteric effect that occurs due to play in the fitment of parts, increases the difficulty of antenna adjustment. The bolt can be tightened to pre-load the vertical walls to reduce clearance, which reduces backlash.

The pivot saddle 22 may be formed primarily from pressed or stamped steel, with the resulting assembly having light weight and/or high strength. In some embodiments, the pivot saddle 22 may be stamped from a sheet of 2-3 mm thick galvanized steel. Moreover, by being formed from pressed steel instead of, for example, die casting or extrusion techniques, the pivot saddle 22 may be manufactured at relatively low cost.

FIGS. 11(A) to 11(D) are several views of a pivot base 20 of on antenna mount 100 according to some embodiments. In particular, FIG. 11(A) is a perspective view, FIG. 11(B) is a top view, FIG. 11(C) is a side view and FIG. 11(D) is a front view of a pivot base 20 of an antenna mount 100 according to some embodiments. Referring to FIGS. 11(A) to 11(D), the pivot base 20 includes an upper support 82, a lower support 84, and a pivot base wall 78 extending between the upper support 82 and the lower support 84. As can be further seen in FIGS. 11(A) and 11(B), the pivot arm support plate 38 extends from an end of the pivot base wall 78. The pivot base wall 78, upper support 82, lower support 84 and pivot arm support plate 38 may all be formed from a single sheet of steel through pressing or stamping. In some embodiments, the pivot base 20 may be stamped from a sheet of 3-4 mm thick galvanized steel. The resulting pivot base 20 may thereby have light weight and/or high strength. Moreover, by being formed from pressed steel, the pivot base 20 may be manufactured at relatively low cost.

Carriage bolt holes 80 are provided in the pivot base wall 78 on opposite sides of the receiving cavity 56 for attaching the carriage bolls 50 and have a square shape to prevent rotation of the carriage bolts 50.

The pivot base 20 includes a receiving cavity 56 that is configured to engage a support pole 42. The receiving cavity 56 includes a pair of receiving surfaces 54 in both the upper and lower supports 82, 84 that are arranged to form an obtuse angle θ₁, so that at least a part of the support pole 42 fits into the receiving cavity 56 when the antenna mount 100 is attached to the support pole 42. The receiving surfaces 54 may be generally linear, and may include a plurality of teeth 58 arranged to engage support poles of various sizes, as illustrated, for example, in FIGS. 8 and 9. In particular, the teeth 58 may be arranged such that at least two teeth 58 on each receiving surface 54 engage the outer surface of the support pole 42 when the receiving surfaces 54 of the pivot base 20 are brought in to contact with the support pole 42, for support poles 42 having various conventional diameters (e.g., 50 mm, 60 mm, 75 mm, 100 mm and 115 mm). In some embodiments, the size and spacing of each tooth may be individually selected or adjusted such that at least two teeth 58 on each receiving surface 54 engage the outer surface of the support pole 42 when the receiving surfaces 54 of the pivot base 20 are brought in to contact with the support pole 42, for support poles 42 having various conventional diameters. In general, the size of each tooth may decrease from an outer portion of the receiving cavity 56 to an inner portion of the receiving cavity 56. Moreover, a depth of the receiving cavity 56 may be less than a radius of the smallest diameter support pole 42 that the pivot base 20 is designed to engage (e.g, less than 25 mm).

FIGS. 12(A) to 12(F) are several views of on azimuth adjustment fastening block 36 of an antenna mount 100 according to some embodiments. In particular, FIG. 12(A) is atop view, FIG. 12(B) is a side view, FIG. 12(C) is a cross sectional view taken along section line D-D of FIG. 12(D). FIG. 12(D) is a front view, and FIGS. 12(E) and 12(F) are perspective views of an azimuth adjustment fastening block 36 that can be used with an antenna mount 100 according to some embodiments.

As best seen in FIGS. 12(C) and 12(D), the azimuth adjustment fastening block 36 includes a through hole 41 that is sized to receive the azimuth pivot arm 26 in slidable engagement. The azimuth adjustment fastening block 36 further includes a slot 43 that is transverse to the through hole 41 and that is sized to Fit over the pivot arm support plate 38. When the azimuth adjustment fastening block 36 is installed on the pivot arm support plate 38, the through hole 41 of the azimuth adjustment fastening block 36 aligns with the pivot arm support hole 39 in the pivot arm support plate 38, thereby allowing the azimuth pivot atm 26 to slidably engage both the azimuth adjustment fastening block 36 and the pivot arm support plate 38.

The azimuth adjustment fastening block 36 may be formed of a molded plastic material. In particular, the fastening blocks may be formed from VALOX Resin 420. When the retaining nuts 40 (FIG. 1) are tightened against the azimuth adjustment fastening block 36, the azimuth adjustment fastening block 36 may deform slightly and thereby hold the retaining nuts 40 tight notwithstanding thermal expansion/contraction of the material of the azimuth adjustment fastening block 36. This may enable the pivot arm retaining nuts 40 to remain tight, and therefore the azimuth setting of the antenna assembly 72 to remain stable, even under the influence of heavy loads and/or over a wide range of ambient temperatures.

FIGS. 13(A) to 13(D) are several views of a clamp bracket 24 according to some embodiments. In particular, FIG. 13(A) is a top view, FIG. 13(B) shows perspective views, FIG. 13(C) is a front view, and FIG. 13(D) is a side view of a clomp bracket 24 that can be used with an antenna mount 100 according to some embodiments. FIG. 13(E) is a front view of a clamp bracket 24 according to further embodiments.

The clamp bracket 24 includes an upper bracket plate 45, a lower bracket plate 47 and a bracket wall 49 that extends between the upper bracket plate 45 and the lower bracket plate 47. A bolt retainer 55 is formed at one end of the bracket wall 49, and includes a pair of curved retaining fingers 57 that extend away from the bracket wall 49 on opposite sides of a slotted bolt hole 51. The retaining fingers 57 are curved away from the receiving cavity 56 on the other side of the clamp bracket 24. A closed bolt hole 53 is formed in the bracket wall 49 at the other end of the clamp bracket 24 opposite the slotted bolt hole 51. When the clamp bracket 24 is to be installed on a support pole 42, a retaining nut 52 may be fastened to the carriage bolt 50 before installation. After the clamp bracket 24 is placed against the support pole 42, the retaining nut 52 may be slid over the bolt retainer 55 as the carriage bolt 50 is moved into the slotted bolt hole 51. The bolt retainer 55 discourages the carriage bolt from sliding back out of the slotted bolt hole 51 so that the clamp bracket 24 can be temporarily held in place on the support pole 42 until the retaining nut 52 can be tightened. Moreover, since the retaining nut 52 is fastened to the carriage bolt 50 before installation, the installer is not required to manipulate a loose bolt while installing the antenna mount 100 on a tall antenna tower.

Like the pivot base 20, the clamp bracket 24 includes a receiving cavity 56 that is configured to engage a support pole 42. The receiving cavity 56 includes a pair of receiving surfaces 54 in both the upper and lower bracket plates 45, 47 that are arranged to form an obtuse angle θ₂, so that at least a part of the support pole 42 fits into the receiving cavity 56 when the antenna mount 100 is attached to the support pole 42. The receiving surfaces 54 may be generally linear, and may include a plurality of teeth 58 arranged to engage support poles of various sizes. In particular, the teeth 58 may be arranged such that at least two teeth 58 on each receiving surface 54 engage the outer surface of the support pole 42 when the receiving surfaces 54 of the pivot base 20 are brought in to contact with the support pole 42, for support poles 42 having various conventional diameters (e.g., 50 mm, 60 mm, 75 mm, 100 mm and 115 mm). In some embodiments, the size and spacing of each tooth may be individually selected or adjusted such that at least two teeth 58 on each receiving surface 54 engage the outer surface of the support pole 42 when the receiving surfaces 54 of the pivot base 20 are brought in to contact with the support pole 42, for support poles 42 having various conventional diameters. In general, the size of each tooth may decrease from an outer portion of the receiving cavity 56 to an inner portion of the receiving cavity 56. Moreover, a depth of the receiving cavity 56 may be less than a radius of the smallest diameter support pole 42 that the pivot base 20 is designed to engage (e.g, less than 25 mm).

The receiving surfaces 54 that define the receiving cavity 56 may be formed in the upper and lower bracket plates 45, 47 opposite the bracket wall 49, as illustrated in FIGS. 13(A) to 13(D). However, in some embodiments, the receiving surfaces 54 that define the receiving cavity 56 may be formed in the upper and lower bracket plates 45, 47 on the same side as the bracket wall 49, similar to the manner in which the receiving cavity 56 in the pivot base 20 is formed.

One problem that may occur when the retaining nuts 52 are tightened against the clamp bracket 24 is that the upper bracket plate 45 and the lower bracket plate 47 may splay apart, weakening the attachment to the support pole 42. To discourage such movement, it may be desirable to form the clamp bracket 24 using a high gauge steel, which may increase the weight and/or cost of the bracket 24. In some embodiments, as shown in FIG. 13(E), a pair of bolt holes 90 may be provided on either side of the receiving cavity 56 in the clamp bracket 24, and a retaining bolt 92 may be provided in the bolt holes 90 to hold the upper bracket plate 45 and the lower bracket plate 47 together when the retaining nuts 52 are tightened.

FIGS. 14(A) and 14(B) are views of a clamp bracket 24′ according to further embodiments. The clamp bracket 24′ includes partially conical stiffeners 61 pressed into the clamp bracket 24′ at the corners formed by the upper and lower bracket plates 45, 47 and the bracket wall 49. In particular, FIG. 14(A) is a top view and FIG. 13(B) is a perspective view of a clamp bracket 24′ that can be used with an antenna mount 100 according to some embodiments.

The clamp bracket 24′ also includes a bolt retainer 55 on the slotted bolt hole 51. In the clamp bracket 24′, the bolt retainer 55 is provided as a retaining depression 59 formed at an inner end of the slotted bolt hole 51.

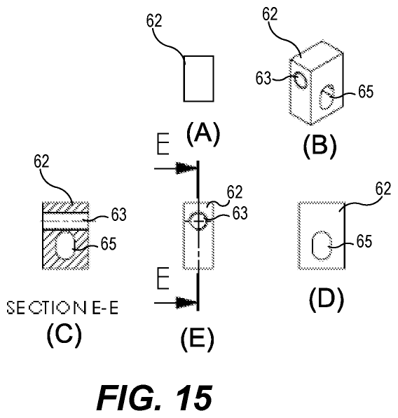

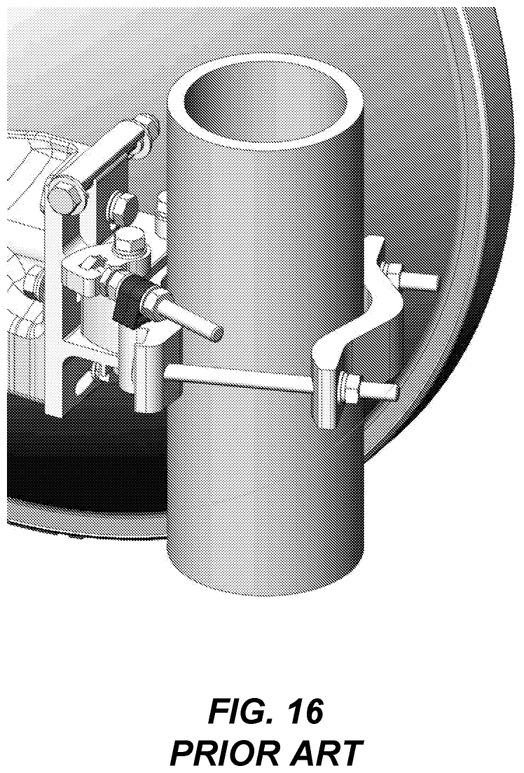

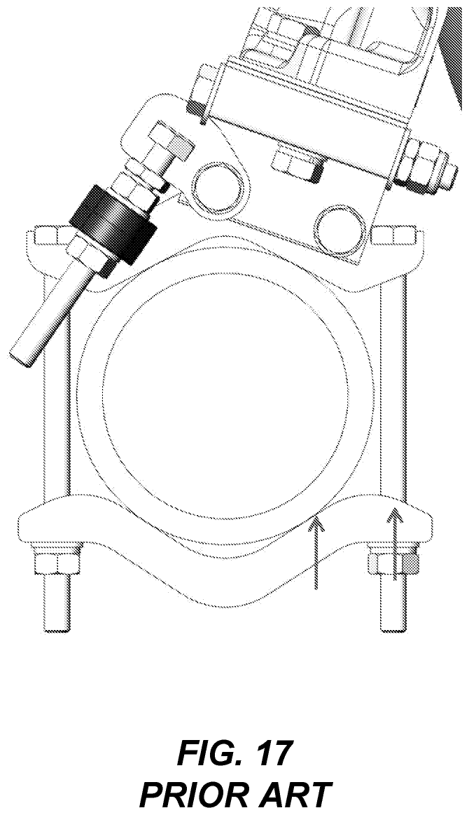

FIGS. 15(A) to 13(E) are several views of an elevation adjustment fastening block 62 of an antenna mount 100 according to some embodiments. In particular, FIG. 15(A) is a top view, FIG. 15(B) is a perspective view, FIG. 15(C) is a cross sectional view taken along line E-E of FIG. 15(E), FIG. 15(D) is a front view and FIG. 15(E) is a side view of an elevation adjustment fastening block 62 of an antenna mount 100 according to some embodiments.

The elevation adjustment fastening block 62 includes a through hole 63 that receives the elevation adjustment bolt 60 (FIG. 2) of the elevation adjustment mechanism. The through hole 63 is sized to allow the elevation adjustment fastening block 62 to slide along the elevation adjustment bolt 60 as the elevation of the antenna assembly 72 is changed. In some embodiments, the interior of the through hole 63 may be threaded to mate with the threads on the elevation adjustment bolt 60. In such embodiments, the elevation adjustment boll 60 may also be threaded to match the threads in the through hole 63, so that the elevation can be adjusted by turning the elevation adjustment bolt 60, which causes the upper attachment bolt 66 to move in the upper elevation adjustment slot 66.

The elevation adjustment fastening block 62 further includes an elongated hole 65 that is formed in a direction transverse to the direction of the through bole 63. The elongated hole 65 is configured to receive the upper attachment bolt 66, and is elongated in the vertical direction to allow the upper attachment bolt 66 to move along the arcuate upper elevation adjustment slot 64 as the elevation of the antenna assembly 72 is adjusted.

The elevation adjustment fastening block 62 may be formed of a material, such as machined nylon, that has appropriate mechanical characteristics. When the upper attachment bolt 66 is tightened against the elevation adjustment fastening block 62, the elevation adjustment fastening block 62 may deform slightly, end thereby hold the upper attachment bolt 66 tight notwithstanding thermal expansion/contraction of the material of the elevation adjustment fastening block 62. This may enable die upper attachment bolt 66 to remain tight, and therefore the elevation setting of the antenna assembly 72 to remain stable, even under the influence of heavy loads and/or over a wide range of ambient temperatures.

Table of Elements

| | |
|---|---|
| 20 | pivot base |
| 22 | pivot saddle |
| 23 | left saddle body |
| 24 | clamp bracket |
| 25 | right saddle body |
| 26 | azimuth pivot arm |
| 27 | pivot arm receiver |
| 28 | azimuth pivot hole |
| 29 | attachment plate |
| 30 | azimuth pivot bolt |
| 31 | vertical axis |
| 32 | pivot arm linkage nut |
| 34 | eye bolt |
| 36 | azimuth adjustment fastening block |
| 38 | pivot arm support plate |
| 39 | pivot arm support hole |
| 40 | pivot arm retaining nut |
| 41 | through hole |
| 42 | support pole |
| 43 | slot |
| 44 | azimuth adjustment guide bolt |
| 45 | upper bracket plate |
| 46 | azimuth adjustment slot |
| 47 | lower bracket plate |
| 48 | azimuth pivot bolt |
| 49 | bracket wall |
| 50 | carriage bolt |
| 51 | slotted bolt hole |
| 52 | retaining nut |
| 53 | closed bolt hole |
| 54 | receiving surface |
| 55 | bolt retainer |
| 56 | receiving cavity |
| 57 | retaining fingers |
| 58 | teeth |
| 59 | retaining depression |
| 60 | elevation adjustment bolt |
| 61 | stiffener |
| 62 | elevation adjustment fastening block |
| 63 | through hole |
| 64 | upper elevation adjustment slot |
| 65 | guide hole |
| 66 | upper attachment bolt |
| 68 | lower elevation adjustment slot |
| 70 | lower attachment bolt |
| 72 | antenna assembly |
| 74 | radio |
| 75 | elevation adjustment nut |
| 76 | feed cable |
| 78 | pivot base wall |
| 80 | carriage bolt hole |
| 82 | upper support |
| 84 | lower support |
| 86 | antenna bracket |
| 88 | antenna dish |
| 90 | bolt holes |
| 91 | weld nut |
| 92 | retaining bolt |
| 93 | main plate |
| 94 | upper plate |
| 95 | lower plate |
| 96 | main plate |
| 97 | upper plate |
| 98 | lower plate |
| 100 | antenna mount |

It will be appreciated that numerous modifications may be made to the above disclosed example embodiments. For example, although described in terms of a mount for a reflector antenna, it will be appreciated that other types of antennas could be mounted using an antenna mount as described herein. Thus, it will be appreciated that the embodiments disclosed herein are merely provided as examples to ensure that the concepts of the present invention are fully disclosed to those of skill in the art.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

1. An antenna mount for mounting an antenna including an antenna bracket to a support member, the antenna mount comprising:
a pivot base configured to be attached to the support member; and
a pivot saddle configured to be attached to the antenna bracket, wherein the pivot saddle is rotatably coupled to the pivot base, and wherein rotation of the pivot saddle about the pivot base changes an azimuth angle of the antenna;
wherein each of the pivot base and the pivot saddle comprises a unitary folded metal part.

2. The antenna mount of claim 1, wherein the pivot base comprises:
an upper support plate;
a lower support plate;
a pivot base wall extending between the upper support plate and the lower support plate;
an azimuth pivot hole in the upper support plate; and
an arcuate azimuth adjustment slot in the upper support plate;
wherein a center of rotation of an arc described by the azimuth adjustment slot corresponds to a center of the azimuth pivot hole.

3. The antenna mount of claim 1, wherein the pivot base further comprises:
receiving surfaces in the upper and lower support plates, the receiving surfaces defining a receiving cavity in the pivot base, the receiving cavity extending through the pivot base wall and configured to receive the support member in engagement with the pivot base.

4. The antenna mount of claim 3, wherein the receiving surfaces comprise outwardly facing teeth configured to engage the support member, wherein the receiving cavity is configured such that at least two teeth on opposing sides of each receiving surface will contact outer surfaces of at least two different cylindrical support members, each of which has a different radius.

5. The antenna mount of claim 3, wherein the receiving cavity has a depth that is less than a smaller radius of the at least two different cylindrical support members.

6. The antenna mount of claim 3, wherein the teeth have sizes that increase outwardly from a center of the receiving cavity.

7. The antenna mount of claim 1, wherein the pivot base further comprises a pivot arm support plate that extends from a side of the pivot base wall, the pivot arm support plate comprising a pivot arm support hole therethrough.

8. The antenna mount of claim 1, wherein the pivot saddle comprises:
an attachment plate configured to receive the antenna bracket;
a first saddle body extending from a first side of the attachment plate; and
a second saddle body extending from a second side of the attachment plate opposite the first side;
wherein the first saddle body includes a hole configured to receive an azimuth adjustment guide bolt that is positioned in the azimuth adjustment slot in the pivot base, and wherein the second saddle body includes a hole therein that is configured to receive an azimuth pivot bolt that is positioned in the azimuth pivot hole in the pivot base.

9. The antenna mount of claim 8, wherein the first saddle body further comprises a pivot arm receiver extending therefrom, the pivot arm receiver configured to be rotatably connected to an azimuth pivot arm that extends through the pivot arm support hole in the pivot arm support plate.

10. The antenna mount of claim 8, further comprising an azimuth adjustment fastening block on the pivot arm support plate, the azimuth adjustment fastening block including a through hole therein that corresponds to the pivot arm support pole, wherein the azimuth pivot arm extends through the pivot arm support hole in the pivot arm support plate and through the through hole in the azimuth adjustment fastening block, wherein the through hole is sized to allow the azimuth pivot arm to slide therethrough.

11. The antenna mount of claim 9, wherein the azimuth pivot arm comprises a threaded bolt, the antenna mount further comprising a pair of pivot arm retaining nuts on the azimuth pivot arm on opposite sides of the azimuth adjustment fastening block.

12. The antenna mount of claim 10, wherein the azimuth adjustment fastening block comprises nylon polymer or resin.

13. The antenna mount of claim 10, wherein the azimuth adjustment fastening block comprises a die cast metal.

14. The antenna mount of claim 10, wherein the azimuth adjustment fastening block comprises a slot therein that is transverse to the through hole and that is configured to fit over the pivot arm support plate.

15. The antenna mount of claim 8, wherein the attachment plate comprises an arcuate elevation adjustment slot that is configured to receive an attachment bolt that attaches to the antenna bracket, the antenna mount further comprising:
an elevation adjustment bolt coupled to the attachment plate;
an elevation adjustment fastening block including a through hole extending through the elevation adjustment fastening block in a first direction and a guide hole extending through the elevation adjustment fastening block in a second direction that is transverse to the first direction;
wherein the elevation adjustment bolt extends through the through hole, and wherein the attachment bolt extends through the guide hole.

16. The antenna mount of claim 15, wherein the guide hole is elongated in one direction.

17. The antenna mount of claim 15, wherein the elevation adjustment slot is tilted away from a vertical direction.

18. The antenna mount of claim 15, wherein the elevation adjustment bolt is threaded and an interior surface of the through hole in the elevation adjustment fastening block is threaded so that when the elevation adjustment bolt is turned, the elevation adjustment fastening block moves linearly along the elevation adjustment bolt and the attachment bolt moves in an arcuate pattern through the elevation adjustment slot.

19. The antenna mount of claim 1, further comprising a mounting bracket configured to be attached to the support member opposite the pivot base.

20. The antenna mount of claim 19, wherein the mounting bracket comprises:
an upper bracket plate;
a lower bracket plate;
a bracket wall extending between the upper bracket plate and the lower bracket plate; and
receiving surfaces in the upper and lower bracket plates, the receiving surfaces defining a receiving cavity in the mounting bracket, the receiving cavity configured to receive the support member in engagement with the mounting bracket.

21. The antenna mount of claim 20, wherein the receiving surfaces comprise outwardly facing teeth configured to engage the support member, wherein the receiving cavity is configured such that at least two teeth on opposing sides of each receiving surface will contact outer surfaces of at least two different cylindrical support members, each of which has a different radius.

22. The antenna mount of claim 20, wherein the receiving cavity has a depth that is less than a smaller radius of the at least two different cylindrical support members.

23. The antenna mount of claim 21, wherein the teeth have sizes that increase outwardly from a center of the receiving cavity.

24. The antenna mount of claim 20, wherein the mounting bracket further comprises:
a closed bolt hole in a first end of the bracket wall; and
an open bolt hole in a second end of the bracket all.

25. The antenna mount of claim 24, further comprising a pair of bolt retainers on opposite sides of the open bolt hole, the bolt retainers comprises retaining fingers that extend away from the bracket wall in a direction opposite the receiving cavity.

26. An antenna mount for mounting an antenna including an antenna bracket to a support member, the antenna mount comprising:
a pivot base;
a pivot saddle, wherein the pivot saddle is rotatably coupled to the pivot base, and wherein rotation of the pivot saddle about the pivot base changes an azimuth angle of the antenna; and
a mounting bracket, wherein the mounting bracket is attached to the pivot base by a pair of bolts that extend on opposite sides of the support member;
an azimuth pivot arm that is slidably coupled to the pivot base along a central portion of the pivot arm and that is rotatably coupled to the pivot saddle at an end of the pivot arm;
an azimuth pivot bolt that extends through the pivot base and the pivot saddle, wherein the pivot saddle rotates around the azimuth pivot bolt in response to the azimuth pivot arm being extended or retracted;
an arcuate azimuth adjustment slot in the pivot base;
an azimuth adjustment guide bolt that extends through the azimuth adjustment slot and connects to the pivot saddle;
an azimuth adjustment fastening block connected to the pivot base, wherein the azimuth pivot arm extends through a hole in the azimuth adjustment fastening block; and
a pair of pivot arm retaining nuts attached to the azimuth pivot on opposite sides of the azimuth adjustment fastening block.
